(19) United States
(12) Patent Application Publication
(10) Pub. No.: US 2019/0249745 A1
(43) Pub. Date: Aug. 15, 2019

(54) AIR SPRING FOR A HEAVY-DUTY VEHICLE

(71) Applicant: HENDRICKSON USA, L.L.C., Itasca, IL (US)

(72) Inventor: Thomas J. Long, Canton, OH (US)

(21) Appl. No.: 16/269,650

(22) Filed: Feb. 7, 2019

Related U.S. Application Data
(60) Provisional application No. 62/628,628, filed on Feb. 9, 2018.

(51) Int. Cl. F16F 9/58; B60G 5/06; B60G 11/27; F16F 9/04

(52) U.S. Cl. CPC F16F 9/585; B60G 5/06; B60G 11/27; F16F 2230/0023; F16F 9/0454; B60G 2202/152; F16F 2222/126; F16F 9/0427

(57) ABSTRACT

An air spring for use in an axle/suspension system of a heavy-duty vehicle includes a bellows and a piston. The bellows includes a bellows chamber. The piston includes a top portion, a bottom portion and a support stud. The support stud includes a first end and a second end, the first end of the support stud is secured to the top portion or the bottom portion of the piston, the support stud extending between the top portion and the bottom portion of the piston.

### CROSS-REFERENCE TO RELATED APPLICATION

This application claims the benefit of U.S. Provisional Application Ser. No. 62/628,628, filed Feb. 9, 2018.

### BACKGROUND OF THE INVENTION

### Field of the Invention

The invention relates generally to the art of axle/suspension systems for heavy-duty vehicles. More particularly, the invention relates to air-ride axle/suspension systems for heavy-duty vehicles which utilize an air spring to cushion the ride of the vehicle. More specifically, the invention is directed to a piston for an air spring of a heavy-duty vehicle air-ride axle/suspension system, in which the air spring piston is made from a composite material and is formed of at least two parts, an upper or top portion and a lower or bottom portion, that cooperate with one another to form an enclosed piston chamber volume. Even more specifically, the invention is directed to a two piece composite piston for an air spring in which a support stud is secured to or embedded into the piston bottom portion and is utilized to attach the upper and lower piston portions together, and also to attach an internal bumper. The secured and/or embedded support stud provides a relatively simple method for attaching the upper and lower piston portions that does not require the utilization of more complicated friction welding methods and provides increased centralized support to the piston, allowing for the use of an internal bumper which decreases the overall air spring cost and weight as compared to air springs that utilize an external bumper, reduces manufacturing complexity of the air spring piston and increases durability of the air spring.

### Background Art

The use of one or more air-ride trailing and leading arm rigid beam-type axle/suspension systems has been popular in the heavy-duty truck and tractor-trailer industry for many years.

Although such axle/suspension systems can be found in widely varying structural forms, in general their structure is similar in that each system typically includes at least a pair of suspension assemblies. In some heavy-duty vehicles, the suspension assemblies are connected directly to the primary frame of the vehicle. In other heavy-duty vehicles, the primary frame of the vehicle supports a subframe, and the suspension assemblies connect directly to the subframe. For those heavy-duty vehicles that support a subframe, the subframe can be non-movable or movable, the latter being commonly referred to as a slider box, slider subframe, slider undercarriage, or secondary slider frame. For the purpose of convenience and clarity, reference herein will be made to main members, with the understanding that such reference is by way of example, and that the present invention applies to heavy-duty vehicle axle/suspension systems suspended from main members of: primary frames, movable subframes, and non-movable subframes.

Specifically, each suspension assembly of an axle/suspension system includes a longitudinally extending elongated beam. Each beam typically is located adjacent to and below a respective one of a pair of spaced-apart longitudinally extending main members and one or more cross members, which form the frame of the vehicle. More specifically, each beam is pivotally connected at one of its ends to a hanger or frame bracket, which in turn is attached to and depends from a respective one of the main members of the vehicle. An axle extends transversely between and typically is connected by some means to the beams of the pair of suspension assemblies at a selected location from about the mid-point of each beam to the end of the beam opposite from its pivotal connection end. The beam opposite the pivotal connection end also is connected to an air spring, or its equivalent, which in turn is connected to a respective one of the main members. A height control valve is mounted on the hanger or other support structure and is operatively connected to the beam and to the air spring in order to maintain the ride height of the vehicle. A brake system and one or more shock absorbers for providing damping to the vehicle axle/suspension system also may be included. The beam may extend rearwardly or frontwardly from the pivotal connection relative to the front of the vehicle, thus defining what are typically referred to as trailing arm or leading arm axle/suspension systems, respectively. However, for purposes of the description contained herein, it is understood that the term “trailing arm” will encompass beams which extend either rearwardly or frontwardly with respect to the front end of the vehicle.

The axle/suspension systems of the heavy-duty vehicle act to cushion the ride, dampen vibrations, and stabilize the vehicle. More particularly, as the vehicle is traveling over the road, its wheels encounter road conditions that impart various forces, loads, and/or stresses, collectively referred to herein as forces, to the respective axle on which the wheels are mounted, and in turn, to the suspension assemblies that are connected to and support the axle. In order to minimize the detrimental effect of these forces on the vehicle and/or its cargo as it is operating, the axle/suspension system is designed to react and/or absorb at least some of them.

These forces include vertical forces caused by vertical movement of the wheels as they encounter certain road conditions, fore-aft forces caused by acceleration and deceleration of the vehicle due to operation of the vehicle and/or road conditions, and lateral and torsional forces associated with transverse vehicle movement, such as turning of the vehicle and lane-change maneuvers. In order to address such disparate forces, axle/suspension systems have differing structural requirements. More particularly, it is desirable for an axle/suspension system to minimize the amount of sway experienced by the vehicle and thus provide what is known in the art as roll stability. However, it is also desirable for an axle/suspension system to be relatively flexible to assist in cushioning the vehicle from vertical impacts, and to provide compliance so that the components of the axle/suspension system resist failure, thereby increasing durability of the axle/suspension system. It is also desirable to dampen the vibrations or oscillations that result from such forces in order to reduce wheel and/or suspension bounce, which in turn can potentially harm the wheels and the components of the axle/suspension system, thereby reducing optimal ride characteristics of the axle/suspension system. A key component of the axle/suspension system that cushions the ride of the vehicle from vertical impacts is the air spring or other spring mechanism, such as a coil spring or a leaf spring, while a shock absorber typically provides damping to the axle/suspension system.

The typical air spring of the type utilized in heavy-duty air-ride axle/suspension systems includes three main components: a flexible bellows, a bellows top plate, and a piston. The bellows is typically formed from rubber or other flexible material, and is sealingly engaged with the bellows top plate and also the top portion of the piston. The volume of pressurized air, or “air volume”, that is contained within the air spring is a major factor in determining the spring rate of the air spring. More specifically, this air volume is contained within the bellows and, in some cases, the piston of the air spring. Usually, the larger the air volume of the air spring, the lower the spring rate of the air spring. A lower spring rate is generally more desirable in the heavy-duty vehicle industry because it allows for softer ride characteristics for the vehicle. Typically, the piston either contains a hollow cavity, which is in communication with the bellows and which adds to the air volume of the air spring by allowing unrestricted communication of air between the piston and the bellows volumes, or the piston has a generally hollow cylindrical-shape and does not communicate with the bellows volume, whereby the piston does not contribute to the air volume of the air spring. In any event, the air volume of the air spring is in fluid communication with an air source, such as an air supply tank, and also is in fluid communication with the height control valve of the vehicle. The height control valve, by directing air flow into and out of the air spring of the axle/suspension system, helps maintain the desired ride height of the vehicle.

Prior art air spring pistons are generally cylindrical shaped and include a sidewall attached to a generally flat or otherwise suitably shaped bottom plate. A top plate is formed at the top of the piston. The bottom plate is formed with upwardly extending central hubs and a central opening. A fastener is disposed through the opening in the central hub bottom plate in order to attach the piston to the beam of the suspension assembly at its rear end. The top plate of the piston is formed with a circular upwardly extending protrusion having a lip or barb around its circumference. The barb cooperates with the lowermost end of the air spring bellows to form an airtight seal between the bellows and the piston. In air springs utilizing an internal bump stop, a bumper is attached to a bumper mounting plate, which is in turn mounted on the piston top plate by a fastener. The bumper extends upwardly from the top surface of the bumper mounting plate and serves as a cushion between the piston top plate and the bellows top plate in order to cushion contact between the two plates during severe operating events of the vehicle. Alternatively, in air springs utilizing an external bump stop, the bumper is mounted to the suspension assembly of the axle/suspension system apart from the air spring, but still prevents the piston top plate and the bellows top plate from contacting one another during severe operating events The piston is typically formed from steel, aluminum, fiber reinforced plastic, composite material, or other rigid material.

Prior art air spring piston designs utilizing composite material generally include a two-part composite piston in which both parts are friction welded together. The two-piece air spring piston design may optionally include an opening that provides fluid communication between the common piston volume and the air spring bellows volume which depending on the size of the opening and restrictive nature of the fluid communication through the opening will either reduce spring rate to increase the soft-ride characteristics of the air spring or provide damping characteristics to the air spring.

A drawback of the prior art piston utilizing a two piece friction welded design is that an external bump stop typically must be used with the design. More specifically, as a result of the friction welding process used to weld the composite pieces together, only the outermost diameter of the piston is typically optimally welded. This occurs because friction welding of the piston parts occurs more readily at the outermost contacts of the dual piston parts, as they have a much higher velocity than the inner most contacts. The decreased velocities of the internal column contacts can potentially result in an incomplete friction weld, leaving the piston inner columns with reduced support. As described above, in air springs utilizing an internal bump stop, a bumper is typically attached to the top surface of the air spring piston, extending upward toward the bellows top plate. Alternatively, an internal bump stop could be mounted on the bellows top plate and extend downwardly toward the piston top plate. Because the friction welded composite pistons potentially do not have fully supported inner columns as a result of the potentially incomplete or sub-optimal friction weld process, the forces created by an internal bump stop during a low air pressure or no air pressure event can potentially cause the piston to collapse or fracture.

To avoid the risk of such piston damage, the thickness of the inner columns and sidewalls may be increased. Alternatively, an external bump stop may be mounted to the suspension assembly of the axle/suspension system instead of utilizing an internal bump stop, in order to sufficiently redirect the force of a vertical impact away from the air spring. As a result prior art pistons utilize an increased amount of material which increases the weight of the overall axle/suspension system.

The present invention overcomes the problems associated with prior art piston designs by including a support stud system integrally molded into the center of one of the two piston pieces. More specifically, a support stud is secured to or molded into the central portion of the bottom piece of the two-part piston and extends upwardly through a clearance hole situated in the center of the top plate of the piston. The support stud connects the bottom and top portions of the friction welded piston together. The stud also provides central support to the piston, allowing thinner internal columns and sidewalls and an internal bump stop to be utilized in conjunction with the composite piston, thereby reducing the material cost associated with an external bumper. Additionally, the overall weight of the system is reduced while still providing the benefits of a composite piston design, as well as increasing durability of the air spring.

### SUMMARY OF THE INVENTION

Objectives of the present invention include providing an air spring that includes a piston having a support stud that provides additional connection support for the top and bottom portions of the friction welded piston.

A further objective of the present invention is to provide an air spring that provides additional central support to the piston of the air spring, allowing thinner internal columns and sidewalls and an internal bump stop to be utilized in conjunction with the composite piston, thereby reducing the material cost associated with an external bumper.

Yet another objective of the present invention is to provide an air spring having reduced weight while still providing the benefits of incorporating a composite piston design.

Still another objective of the present invention is to provide an air spring with increased durability.

These objectives and advantages are obtained by the air spring of the present invention which includes a bellows; and a piston having at least a top portion, a bottom portion and a support stud. The support stud includes a first end and a second end, the first end of the support stud being secured to the top portion or the bottom portion of the piston. The support stud extends between the top portion and the bottom portion of the piston.

### BRIEF DESCRIPTION OF THE SEVERAL VIEWS OF THE DRAWINGS

The preferred embodiment of the present invention, illustrative of the best mode in which applicants have contemplated applying the principles, is set forth in the following description and is shown in the drawings, and is particularly and distinctly pointed out and set forth in the appended claims.

FIG. 1 is a top rear perspective view of an air-ride trailing arm heavy-duty trailer prior art axle/suspension system incorporating a pair of prior art air springs mounted on respective suspension assemblies of the axle/suspension system;

FIG. 2 is an elevational view in section of a prior art heavy-duty air spring, showing a two-piece friction welded composite piston with an internal bumper mounted on the top plate of the piston;

FIG. 3 is an elevational view in section of an exemplary embodiment air spring of the subject disclosure, showing the stud embedded in the piston bottom portion and extending upwardly through and opening in the piston top plate to provide support to the center of the piston and attach the internal bumper to the piston top plate;

FIG. 4 is an enlarged sectional view of the exemplary embodiment air spring shown in FIG. 3, with the bellows removed; and

FIG. 5 is an enlarged sectional view of an alternative exemplary embodiment air spring shown in FIG. 4, with the bellows removed.

Similar numerals refer to similar parts throughout the drawings.

### DESCRIPTION OF THE PREFERRED EMBODIMENT

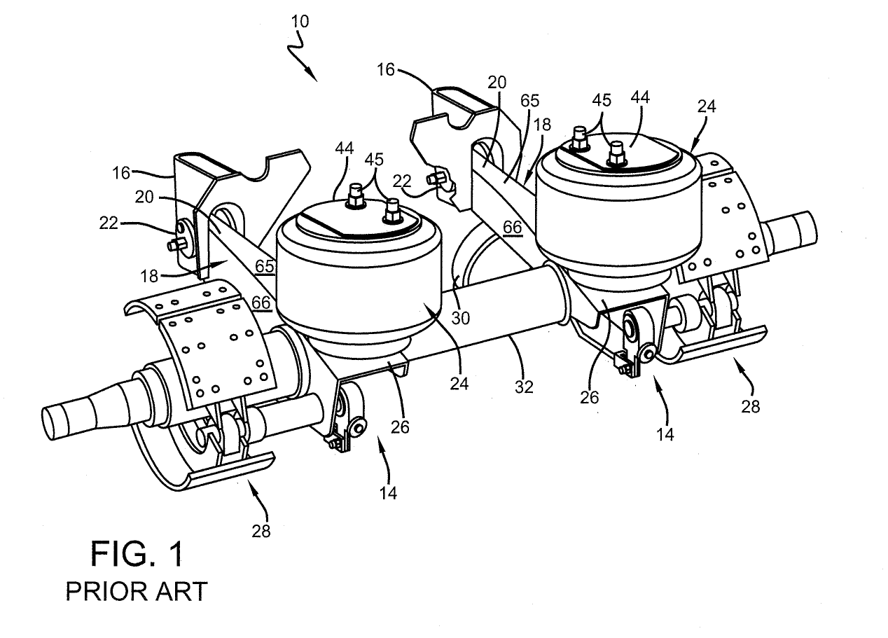

In order to better understand the environment in which the air spring piston for heavy-duty vehicles of the present invention is utilized, a trailing arm overslung beam-type air-ride axle/suspension system that incorporates a pair of prior art heavy-duty vehicle trailer air springs 24, is indicated generally at 10, is shown in FIG. 1, and now will be described in detail below.

It should be noted that axle/suspension system 10 is typically mounted on a pair of longitudinally-extending spaced-apart main members (not shown) of a heavy-duty vehicle, which is generally representative of various types of frames used for heavy-duty vehicles, including primary frames that do not support a subframe and primary frames and/or floor structures that do support a subframe. For primary frames and/or floor structures that do support a subframe, the subframe can be non-movable or movable, the latter being commonly referred to as a slider box. Because axle/suspension system 10 generally includes an identical pair of suspension assemblies 14, for sake of clarity only one of the suspension assemblies will be described below.

Suspension assembly 14 is pivotally connected to a hanger 16 via a trailing arm overslung beam 18. More specifically, beam 18 is formed having a generally upside-down integrally formed U-shape with a pair of sidewalls 66 and a top plate 65, with the open portion of the beam facing generally downwardly. Trailing arm overslung beam 18 includes a front end 20 having a bushing assembly 22, which includes a bushing, pivot bolts and washers as are well known in the art, to facilitate pivotal connection of the beam to hanger 16. Beam 18 also includes a rear end 26, which is welded or otherwise rigidly attached to a transversely extending axle 32. For the sake of relative completeness, a brake system 28 including a brake chamber 30 is shown mounted on prior art suspension assembly 14.

As mentioned above, axle/suspension system 10 is designed to absorb forces that act on the vehicle as it is operating. More particularly, it is desirable for axle/suspension system 10 to resist roll forces and thus provide roll stability for the vehicle. This is typically accomplished by using beam 18, which is rigid, and is rigidly attached to axle 32. It is also desirable, however, for axle/suspension system 10 to be flexible to assist in cushioning the vehicle (not shown) from vertical impacts and to provide compliance so that the axle/suspension system resists failure. Such flexibility typically is achieved through the pivotal connection of beam 18 to hanger 16 with bushing assembly 22. Air spring 24 also assists in cushioning and/or controlling the ride for cargo and/or passengers.

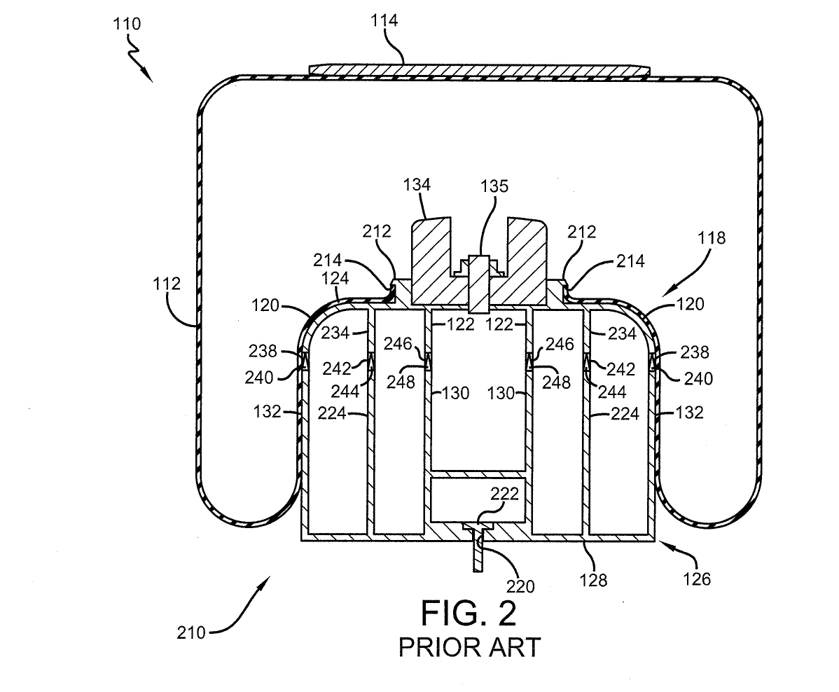

Prior art air spring 24 shown in FIG. 1 is an air spring of the damping type similar to prior art air spring 110 shown in FIG. 2, which now will be described in detail below. With particular reference to FIG. 2, air spring 110 is typically incorporated into an axle/suspension system such as axle/suspension system 10, or other similar air-ride axle/suspension system. Air spring 110 includes a bellows 112, a bellows top plate 114, a bumper 134, and a composite piston 210. The top end of bellows 112 is sealingly engaged with bellows top plate 114 in a manner well known in the art. Bumper 134 is attached to the top portion of composite piston 210 by a fastener 135 in a manner well known in the art. An air spring mounting plate 44 (FIG. 1) is typically mounted on the top surface of top plate 114 by fasteners 45 (FIG. 1) which are also used to mount the top portion of air spring 110 to a respective one of the main members (not shown) of the vehicle. Alternatively, bellows top plate 114 could also be mounted directly on a respective one of the main members (not shown) of the vehicle.

Air spring piston 210 is generally cylindrical-shaped, formed of a composite material and includes a top portion 118 and a bottom portion 126. Piston top portion 118 generally includes a sidewall 120, a central hub 122 and a top plate 124. Piston bottom portion 126 is generally cup-shaped, but may be flat or have any other suitable shape, and includes a correspondingly shaped bottom plate 128, a central hub 130 and a sidewall 132. Piston top portion sidewall 120 extends downwardly from top plate 124 and engages sidewall 132 of piston bottom portion 126.

With particular reference to FIG. 2, top plate 124 also is formed with a generally circular upwardly extending protrusion 212 formed with a lip or barb 214 around its circumference. Protrusion 212 and barb 214 serve as a connecting means for the air spring bellows. More particularly, barb 214 cooperates with the bottom terminal end of air spring bellows 112 to form an airtight seal between the bellows and the barb, as is well known to those of ordinary skill in the art.

Piston bottom portion bottom plate 128 is formed with a central opening 220. A fastener 222 is disposed through opening 220 in order to attach piston 210 to the beam of its respective suspension assembly (not shown).

With continuing reference to FIG. 2, piston top portion 118 is formed with an intermediate cylindrical column 234 that is spaced concentrically between central hub 122 and sidewall 120. Likewise, piston bottom portion 126 is formed with an intermediate cylindrical column 224 that is spaced concentrically between central hub 130 and sidewall 132.

The lower end of top portion sidewall 120 is formed with a groove 238. Groove 238 mates with a correspondingly shaped crest 240 formed on the upper end of sidewall 132 of piston bottom portion 126. Likewise, the lower end of top portion intermediate column 234 is formed with a groove 242. Groove 242 interlocks or mates with correspondingly shaped crest 244 formed on the upper end of piston bottom portion intermediate column 224. In addition, the lower end of top portion central hub 122 is formed with a groove 246. Groove 246 interlocks or mates with correspondingly shaped crest 248 formed on the upper end of piston bottom portion central hub 130. In this manner, grooves 238,242,246 interlock or matingly engage and correspond with crests 240,244,248 respectively, and allow piston bottom portion 126 and piston top portion 118 to be friction welded to one another during assembly of air spring piston 210.

Because of the potential weld degradation of central hubs 122,130 and intermediate columns 234,224 of piston top portion 118 and piston bottom portion 126, respectively, as a result of the friction welding process as described above, central hubs 122,130 and intermediate columns 234,224 are only capable of providing a bearing means to sufficiently/optimally react bumper forces from bumper 134 of the air spring to lower mounting area 222 of piston bottom portion 126 due to increased thickness of the central hubs, intermediate columns, and sidewalls 120,132. Consequently, use of thinner central hubs 122,130; intermediate columns 234,224; and sidewalls 120,132 may require an external bump stop (not shown) mounted on the suspension assembly of the axle/suspension system, which results in increased material cost due to the additional material needed to manufacture the larger external bump stop. Additionally, as a result of increased thickness of the central hubs 122,130; intermediate columns 234,224; and sidewalls 120,132 and the larger external bump stop, the overall weight of the axle/suspension system is increased. The present invention overcomes the limitations of the prior art composite air springs and will now be described in detail below.

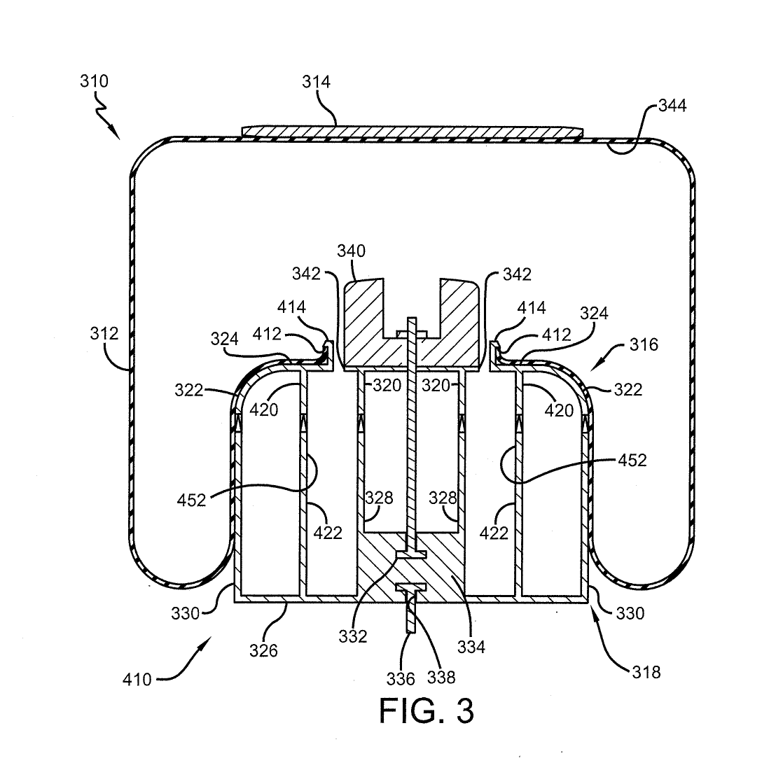

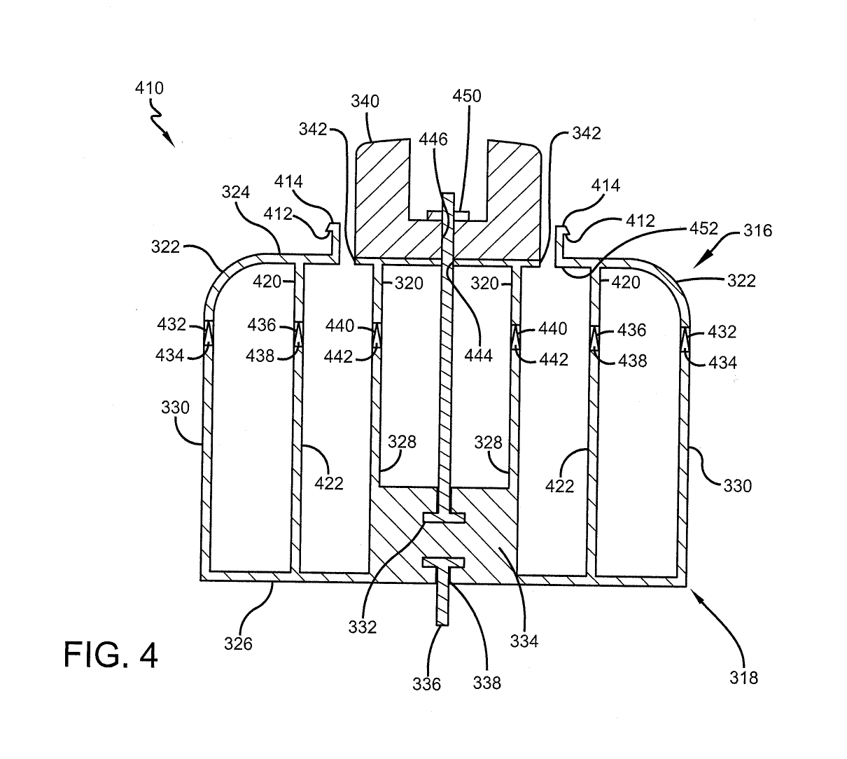

A preferred embodiment air spring of the present invention is shown in FIGS. 3 and 4, and is indicated generally at 310. Preferred embodiment air spring 310 includes a bellows 312, a bellows top plate 314, and a piston 410. The top end of the bellows 312 is sealingly engaged with the bellows top plate 314 in a manner well known in the art. An air spring mounting plate (not shown) is mounted on the top surface of the top plate by fasteners (not shown) which are also used to mount the top portion of the air spring to a respective one of the main members (not shown) of the vehicle frame. Alternatively, the bellows top plate 314 could be mounted directly on a respective one of the main members (not shown) of the vehicle frame.

Preferred embodiment air spring piston 410 is generally cylindrical-shaped, formed of a composite material, and includes a top portion 316 and a bottom portion 318. Piston top portion 316 includes a sidewall 322, a central hub 320, a top plate 324, and a bumper 340. Piston bottom portion 318 is cup-shaped and generally includes a flat bottom plate 326. Alternatively, piston bottom portion 318 may have any other suitable shape. More specifically, piston bottom portion 318 may have a raised central portion formed by an incline from sidewall 330 toward central hub 328. Accordingly, bottom plate 326 may have a corresponding shape, such as a conical frustum. Bottom portion 318 also includes a central hub 328, a central molding 334, a support stud 332, and a sidewall 330. Piston top portion sidewall 322 extends downwardly from top plate 324 and engages sidewall 330 of piston bottom portion 318. In accordance with an important feature of the present invention, support stud 332 is embedded in central molding 334 and will be described in greater detail below.

With particular reference to FIGS. 3 and 4, top plate 324 is formed with a generally circular upwardly extending protrusion 414 formed with a lip or barb 412 around its circumference. Protrusion 414 and barb 412 serve as a connecting means for air spring bellows 312. More particularly, barb 412 cooperates with the bottom terminal end of air spring bellows 312 to form an airtight seal between the bellows and the barb.

Piston bottom portion bottom plate 326 is formed with a central opening 338. A fastener 336 is secured to or embedded into central molding 334 and extends downwardly through bottom plate 326 central opening 338 in order to attach piston 410 to the beam of its respective suspension assembly (not shown).

With reference to FIGS. 3 and 4, piston top portion 316 is formed with an intermediate cylindrical column 420 that is spaced concentrically between central hub 320 and sidewall 322. Likewise, piston bottom portion 318 is formed with an intermediate cylindrical column 422 that is spaced concentrically between central hub 328 and sidewall 330.

With particular reference to FIG. 4, the lower end of top portion sidewall 322 is formed with a groove 432. Groove 432 mates with a correspondingly shaped crest 434 formed on the upper end of sidewall 330 of piston bottom portion 318. Likewise, the lower end of top portion intermediate column 420 is formed with a groove 436. Groove 436 interlocks or mates with correspondingly shaped crest 438 formed on the upper end of piston bottom portion intermediate column 422. In addition, the lower end of top portion central hub 320 is formed with a groove 440. Groove 440 interlocks or mates with correspondingly shaped crest 442 formed on the upper end of piston bottom portion central hub 328. In this manner, grooves 432,436,440 interlock or matingly engage and correspond with crests 434,438,442 respectively, and in addition to support stud 332, allow piston bottom portion 318 and piston top portion 316 to be friction welded to one another during assembly of air spring piston 410.

With particular reference to FIGS. 3 and 4, top plate 324 also is formed with a pair of openings 342, which allow the volume of a piston chamber 452 and the volume of a bellows chamber 344 of the air spring to communicate with one another during operation of the vehicle. More particularly, openings 342 allow fluid or air to pass between piston chamber 452 and bellows chamber 344 during operation of the vehicle. This communication between piston chamber 452 and bellows chamber 344 through openings 342 provides damping to the air spring as described and shown in U.S. Pat. No. 8,540,222, owned by Hendrickson USA, L.L.C.

In accordance with an important feature of the present invention, support stud 332 is embedded within central molding 334 and is utilized to provide centralized support to air spring piston 410, as well as to clamp piston bottom portion 318, piston top portion 316, and bumper 340 together. More specifically, support stud 332 is embedded within piston bottom portion central molding 334 and extends centrally and vertically upwardly through piston bottom portion 318, piston top portion 316, and also extends through a central opening 444 formed in top plate 324 and a central opening 446 formed in bumper 340, which is seated centrally on top portion top plate 324. A fastener 450, in conjunction with stud 332, fastens bumper 340, piston top portion 316, and piston bottom portion 318 together, providing centralized support to the composite piston. Alternatively, support stud 332 may be secured to central molding 334 using suitable attachment means, such as adhesive or weldments and the like.

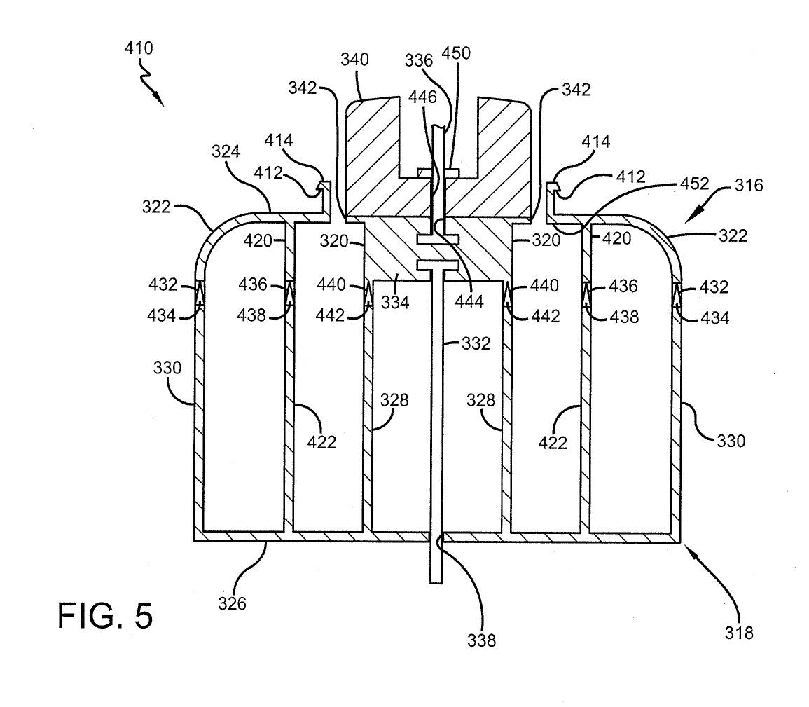

It should be understood that central molding 334, could also be alternatively formed in the piston top portion 316 as shown in FIG. 5, with central stud 332 secured to or embedded in the central molding and extending downwardly through an opening 338 formed in piston bottom portion 318 to provide centralized support to air spring piston 410, as well as to clamp the piston top portion and the piston bottom portion together. In this configuration, fastener 336 is also embedded in central molding 334 and extends upwardly through bumper opening 446. A nut 450 is disposed on the end of fastener 336 in order to attach the bumper to piston top plate 324. Improved air spring 310 for heavy-duty vehicles of the present invention overcomes the problems associated with prior art air springs by providing a composite air spring piston, formed by the combination of two separate parts, with a centrally embedded support stud 332. As a heavy-duty vehicle is traveling on the road, its wheels can encounter road conditions that impart vertical forces on the wheel. Under normal conditions, the forces transfer through the respective axle, the suspension assembly, and to air spring piston 410, where the loads are reacted by the pressurized air spring bellows 312. In the event that air spring 310 is not optimally pressurized or the road condition encountered imparts excessive vertical force on the wheel, such as when the vehicle tire contacts a curb or pothole, the upward force imparted on air spring piston 410 can overcome the reactive force of the pressurized bellows chamber 344, causing bumper 340 of the air spring piston to travel upwardly and strike bellows top plate 314. Under such circumstances, these forces are reacted by embedded support stud 332 which extends through the center of piston 410. In such an impact, centrally embedded support stud 332 of the present invention provides a more direct load path to react the forces, instead of relying on thicker central hub 320,328; intermediate cylindrical columns 420,422; and sidewalls 322,330 to react such forces, as was prevalent in the prior art. The present invention provides a bearing means to sufficiently/optimally react the upward forces originating from a wheel vertical impact as described above, eliminating the potential of piston 410 collapsing upon contact with bellows top plate 314, and increasing the durability of air spring 310. As a result, the improved damping characteristics of the composite piston design can now be utilized with the cost and weight saving benefits of thinner construction and the internal bump stop design. In addition, the present invention overcomes the potential deficiencies of friction welding shown in the prior art.

It is contemplated that preferred embodiment air spring 310 incorporating piston 410 of the present invention could be utilized on heavy-duty vehicles such as trucks, tractor-trailers, buses, straight trucks, and the like, having one or more axles without changing the overall concept or operation of the present invention. It is further contemplated that air spring 310 incorporating piston 410 of the current invention could be utilized on vehicles having frames or subframes which are moveable or non-moveable without changing the overall concept of the present invention. It is further contemplated that air spring 310 incorporating air spring piston 410 of the present invention could be utilized on all types of air-ride leading and/or trailing arm beam-type axle/suspension systems designs know to those skilled in the art without changing the overall concept and operation of the present invention. It is also contemplated that air spring 310 incorporating air spring piston 410 could be utilized on axle/suspension systems having either an overslung/top-mount configuration or an underslung/bottom-mount configuration, without changing the overall concept and operation of the present invention. The present invention also finds application in intermediary structures such as spring seats. It is also contemplated that air spring 310 incorporating air spring piston 410 of the present invention could be used with other types of air-ride rigid beam-type axle/suspension systems such as those using U-bolts, U-bolt brackets/axle seats and the like, without changing the overall concept or operation of the present invention. It is also contemplated that preferred embodiment air spring piston 410 of the present invention could be formed from various materials, including but not limited to composites, metal and the like, without changing the overall concept or operation of the present invention. It is also contemplated that preferred embodiment air spring 310 of the present invention could be utilized with fewer or more than two openings 342, or no openings, without changing the overall concept or operation of the present invention. It is also contemplated that preferred embodiment air spring 310 of the present invention could be utilized with any viscous fluid, such as air or hydraulic fluid, without changing the overall concept or operation of the present invention. It is also contemplated that preferred embodiment air spring 310 of the present invention could be utilized with all types of damping or non-damping air springs without changing the overall concept or operation of the present invention. It is yet even further contemplated that air spring 310 could be formed with support stud 332 molded into a central molding 334 formed in piston top portion 316 and attached to a fastener used to connect piston bottom portion 318 to the beam of the axle/suspension system, in order to connect the piston top portion to the piston bottom portion and to connect the air spring piston to the beam of the axle/suspension system, without changing the overall concept or operation of the present invention. It is even further contemplated that preferred embodiment air spring 310 of the present invention could be utilized with any type of internal bumper, including those mounted to the piston top plate or the bellows top plate, and the like, without changing the overall concept or operation of the present invention.

The present invention has been described with reference to a specific embodiment. It is to be understood that this illustration is by way an example and not by way of limitation. Potential modifications and alterations will occur to others upon a reading and understanding of this disclosure, and it is understood that the invention includes all such modifications, alterations, and equivalents thereof. Accordingly, the air spring is simplified, provides an effective, safe, inexpensive and efficient structure and method which achieves all the enumerated objectives, provides for eliminating difficulties encountered with prior art air springs, and solves problems and obtains new results in the art.

In the foregoing description, certain terms have been used for brevity, clearness and understanding; but no unnecessary limitations are to be implied therefrom beyond the requirements of the prior art, because such terms are used for descriptive purposes and are intended to be broadly construed.

Moreover, the description and illustration of the invention is by way of example, and the scope of the invention is not limited to the exact details shown or described.

Having now described the features, discoveries and principles of the invention, the manner in which the air spring is used and installed, the characteristics of the construction, arrangement and method steps, and the advantageous, new and useful results obtained; the new and useful structures, devices, elements, arrangements, process, parts and combinations are set forth in the appended claims.

What is claimed is:

1. An air spring for use in an axle/suspension system of a heavy-duty vehicle, the air spring comprising:
a bellows; and
a piston having at least a top portion, a bottom portion and a support stud, said support stud including a first end and a second end, said first end of the support stud being secured to said top portion or said bottom portion of said piston, said support stud extending between the top portion and the bottom portion of the piston.

2. The air spring for use in an axle/suspension system of a heavy-duty vehicle of claim 1, wherein said first end of said support stud securement comprises embedding the first end of the support stud in said bottom portion of said piston, said second end of said support stud extending through said piston top portion.

3. The air spring for use in an axle/suspension system of a heavy-duty vehicle of claim 2, said piston top portion and said piston bottom portion each including a corresponding central hub, said bottom portion central hub including a central molded section.

4. The air spring for use in an axle/suspension system of a heavy-duty vehicle of claim 3, said support stud being embedded in said central molded section of said bottom portion central hub.

5. The air spring for use in an axle/suspension system of a heavy-duty vehicle of claim 4, said bottom portion of said piston further comprising a fastener embedded in said central molded section of said bottom portion central hub, said fastener extending away from said support stud.

6. The air spring for use in an axle/suspension system of a heavy-duty vehicle of claim 1, said top portion and said bottom portion of said piston further comprising corresponding sidewalls and corresponding intermediate columns concentrically spaced between said corresponding sidewalls and said corresponding central hubs.

7. The air spring for use in an axle/suspension system of a heavy-duty vehicle of claim 6, said top portion sidewalls and top portion intermediate columns are formed with grooves.

8. The air spring for use in an axle/suspension system of a heavy-duty vehicle of claim 7, said bottom portion sidewalls and said bottom portion intermediate columns are formed with crests corresponding to said grooves.

9. The air spring for use in an axle/suspension system of a heavy-duty vehicle of claim 1, said air spring further comprising a bumper disposed with said bellows chamber.

10. The air spring for use in an axle/suspension system of a heavy-duty vehicle of claim 9, said support stud extending through said bumper to operatively connect the bumper to said top portion of said piston.

11. The air spring for use in an axle/suspension system of a heavy-duty vehicle of claim 1, said top portion and said bottom portion being joined to form a piston chamber.

12. The air spring for use in an axle/suspension system of a heavy-duty vehicle of claim 11, said top portion of said piston further comprising a top plate including one or more openings for restricted fluid communication between said bellows chamber and said piston chamber.
